(19) United States
(12) Patent Application Publication
(10) Pub. No.: US 2007/0275691 A1
(43) Pub. Date: Nov. 29, 2007

(54) Orientation based message retrieving

(75) Inventor: Peter Boda, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/477,774

(22) Filed: Jun. 30, 2006

(30) Foreign Application Priority Data
May 12, 2006 (FI) 20060470

(51) Int. Cl. H04M 11/04

(52) U.S. Cl. 455/404.2

(57) ABSTRACT

A user interface for mobile devices, which is suitable for retrieving messages and services by pointing a specific point. The device must be equipped with a positioning system and orientation sensors for determining the pointing direction. Then, the direction is sent to a server which determines if there are any defined specific points in the pointing direction. If there are messages for the user for the calculate specific point, the messages will be transmitted to the device.

### FIELD OF THE INVENTION

The invention relates to messaging and proximity services in telecommunication systems. More precisely, how the necessity of being in the proximity of a physical entity can be overwhelmed by utilizing orientation sensing technology in the open physical space.

### BACKGROUND OF THE INVENTION

Spotting, virtual messages, post-it notes, postcards and alike are well known application forms for delivering messages. Messages may be personal or public. One example of a common public message is an advertisement, such as a spot advertisement. These messages are location-specific. The reader of the message has to be in the proximity of the message and also the message may include information that is also location-specific. This is clearly a drawback and the present invention tries to overwhelm this obstacle by introducing a method, which lets users freely utilise the always present public physical space, such as the sky.

The drawback of such conventional messaging is the proximity requirement for the user. If the user is willing to see the message, he/she must be in the proximity of the message. For example, if a post-it note has been attached to a given post, e.g. a street lamp, street corner, etc. the receiver of the message has to visit the post for picking up the message. Thus, different messaging systems have been developed for delivering messages. One popular example is SMS-messages in a mobile environment, which clearly independent of the location of the sender and that of the receiver. However, it implements a push model, meaning that the receiver gets the message when the sender posted it.

Wearable computers have been researched for providing an easier user interface for messaging systems and other applications. One solution is disclosed in an article “An Architecture for Outdoor Wearable Computers to Support Augmented Reality and Multimedia Applications” by Wayne Piekarski et al. However, the wearable computers in this article are big and clumsy. Thus, they are not good for carrying everywhere. Another example of wearable computers is disclosed in article “A Touring Machine: Prototyping 3D Mobile Augmented Reality Systems for Exploring the Urban Environment” by Steven Feiner et al published in the Proceedings of ISCW'97, Oct. 13-14, 1997 in Cambridge, Mass., USA. However, the article shares the same problems as the article by Piekarski.

### SUMMARY OF THE INVENTION

The invention discloses a method and a system for transmitting and receiving messages assigned to specific points, such as celestial bodies or alike by pointing towards the specific point by a device. The system does not require physical presence in a given location, or in other words, the specific points are defined as widely and freely available—either in terms of globally or locally. Global space is referred as the sky, the navigational direction (South, North, etc.) above the horizon, etc. Whereas local space is a larger environment of the user, e.g. the city as whole or the landscape. In the global case a specific point can be a celestical body such as stars, the Moon, etc., while in the local case a well known building, e.g. the Eiffel-tower (not necessarily in the proximity, not even in visual sight), or a landscape mark such as a hill or statue on a mountain top, or any other object, real or virtual, in the open and freely available physical space.

The system according to the present invention comprises a device and a server. The device is equipped with positioning means for locating the device and orientation means for determining the direction of the pointing. The location and orientation information is then sent to the server for computing the actual location of the specific point. Then, the specific point (i.e. the coordinates) will be searched from the database and if there are any messages to the particular user, the messages are delivered by using data communication means. If the specific point, such as the moon, changes the location, the location must be computed from known orbit. Similarly the server is arranged to use other known information, such as navigational directions, in computing the actual location of specific point. Typically, the device is a mobile device into which the positioning and orientation means, such as sensors, have been integrated. Thus, the device includes a regular data communication mechanism. As persons skilled in the art are familiar with several different technologies for data transfer, they are not discussed herein. Furthermore, the server is contacted conventionally using the data communication network. Furthermore, modern mobile devices are capable of executing software. Thus, it is possible to make a proper user interface easily. Messages can be sent similarly by pointing a specific point or by determining the specific point with a computer, e.g. via a web interface using menus, icons, textual input or other means. The messages can be text messages, images, sound clips, multimedia messages or any other suitable messages that can be reproduced in client devices. If the message cannot be reproduced in a certain device, the device can forward the message, for example, to e-mail service.

In one embodiment a second specific point is pointed or with a gesture, e.g. circle is drawn. By using two points or a gesture, it is possible to determine a sector including several specific points. For example, restaurants within the sector may send public messages to users who are willing to receive them. However, it is possible that the same sector includes different types of messages. The user can define if he/she is willing to receive advertisements or alike. Furthermore, naturally the users are not allowed to retrieve all messages. For example, there may be private messages and messages to certain groups.

In one embodiment the user can (pre)define what services he/she wants to be activated by pointing a specific point. These can be also location specific in a sense that a given service is activated depending when and where the user is. For example, if the user points the mobile device to the moon at the summer cottage in the weekend, the device automatically retrieves a weather forecast for fishing, whereas if this is done during the workday anywhere gives the traffic report/forecast. Or in another utilization, on workdays the user might point towards East or West and gets, respectively, market reports and stock analysis for the selected regions. Another example, when the user travels, every evening can check whether his/her partner left a message to the Moon, just by pointing to its current direction.

The invention discloses a new method for collecting useful information and other messages by pointing a specific point that is not part of the immediate proximity of the user but resides e.g. on the sky or in given directions above the horizon or defined by known landmarks, building in the larger environment of the user. The benefit of the invention is that it allows an easy way of collecting information from specific points, such as known buildings, landmarks in the distance, and celestial bodies, orientational directions, etc. In addition to useful messages the present invention can be used for personal messaging and other recreational activities, such as games. Furthermore, specific points can also be used as a bookmark to pre-selected services. Thus, the pointing system provides a better user interface to known devices and implements a seamless user interaction via the approach to services and applications. Additionally, the invention implements a pull model of messaging, meaning that the receiver decides when and how to retrieve personal and/or public messages. And finally, the physical space used to “store” the messages is the one which is available widely and openly to everyone, namely the space around and above us, and not a specific location as in case of the known spotting and virtual post-it messages.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart of an example method according to the present invention,

FIG. 2 is a block diagram of an example embodiment of the present invention.

### DETAILED DESCRIPTION OF THE INVENTION

Reference will now be made in detail to the embodiments of the present invention, examples of which are illustrated in the accompanying drawings.

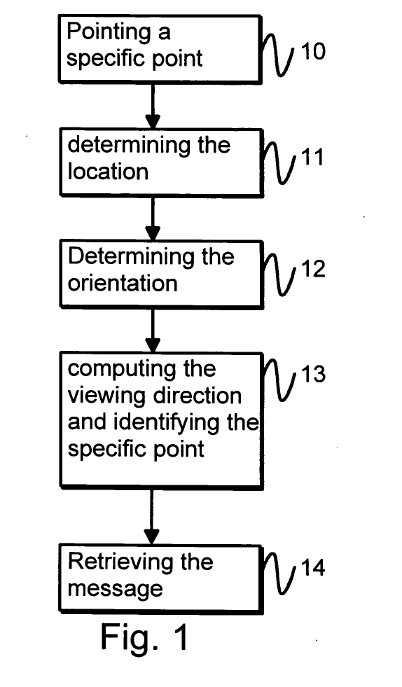

In FIG. 1 a flow chart of an example method according to the present invention is shown. The method according to FIG. 1 requires an ordinary mobile device with a regular data connectivity. Furthermore, the method requires that the mobile device comprises or connected to a positioning system and orientation means. The positioning system may be, for example, a receiver for GPS (Global Positioning System). The positioning system may be replaced with a mobile network positioning system, however, a satellite-based positioning system is more accurate and thus considered better. The orientation means may be any kind of sensors that are capable of providing the orientation of the mobile device. Examples of these sensors are compasses and inclinometers. Thus, it is possible to calculate the direction to which the mobile device is pointing.

The method according to FIG. 1 is initiated by pointing a specific point, step 10. In an embodiment of the present invention it is possible to point more than one point. For example, two points may be pointed for determining a sector. The specific point may be any point whose location can be retrieved from a database or computed from known facts. For example, if the moon is pointed, coordinates for moon must be computed as the pointing direction to the moon varies depending on the time and pointing location. Similarly any other celestial body might be used as a specific point, or navigational directions such as the South, North, West, East, the spot right above the user, etc. Examples of stationary points include big buildings, mountains or specifically constructed points that can be, for example an indication note of possible additional information. In that case the user points the indication note.

After pointing the specific point, the location of the device will be determined, step 11. The most convenient way of determining the location is using an integrated GPS-receiver. However, any other known positioning method may be used for determining the location of the device. Then, the orientation of the device will be determined, step 12. This can be done by using different types of sensors. However, the requirement for the sensors is that the pointing direction can be determined based on the information provided by the sensors.

Based on the orientation and location information the viewing direction from a user to the specific point can be computed, step 13. Based on this information it is possible to compute, i.e. check up in a database, that if there are any specific points having messages for the user in the viewing direction in order to identify the specific point. The available messages are then retrieved from a server to the device, step 14.

The retrieved messages may be personal or public messages. Personal messages can be sent similarly by pointing a specific point and sending the message to the server. It is possible to send the messages also from ordinary computers, e.g. via web pages or by mailing following a specified syntax, by defining the specific point, for example, by naming the receiver and the specific point, such as the moon. Similarly, public messages can be addressed to anyone who is pointing the specific point. A typical example of a public message is an advertisement. For example, a restaurant could send advertisements, a lunch menu or an address to the webpage when the user is pointing the restaurant. In an embodiment where two or more points are determined to form a sector or an area, it is possible that several specific points will be covered. For example, if the user is pointing a sector that covers several restaurants, all of them can send their information to the user. Furthermore, it is possible to determine specific points that are not exactly the specific point but for example a sector left or right from the pointed specific point. This kind of difference must be determined by the user or it is possible to search for messages that are near the pointed specific point.

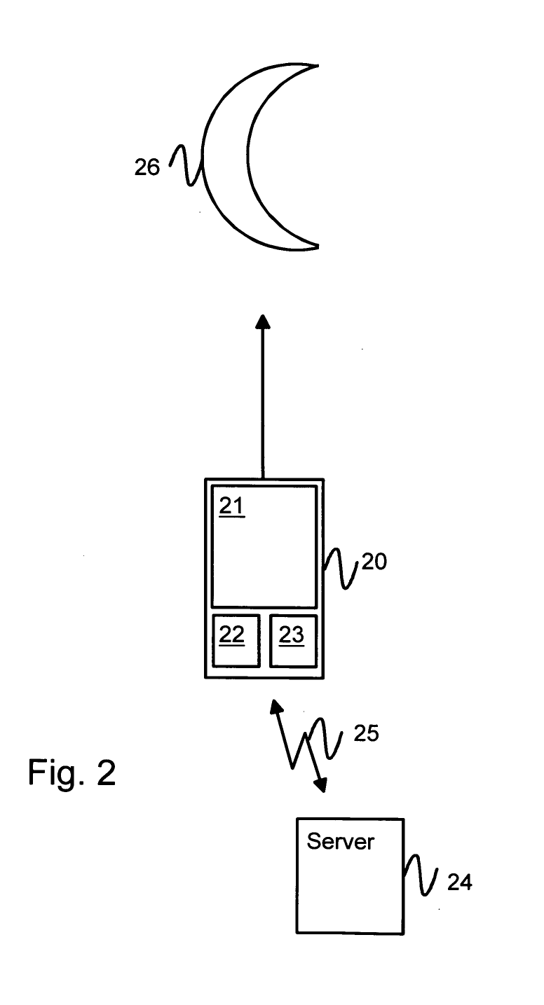

FIG. 2 is a block diagram of an example embodiment of the present invention. The system comprises a device 20 according to the present invention. The device is connected to a server 24 by using network connection 25. The network connection may be any wireless network connection that can be used in mobile devices. Many different networks are known to a person skilled in the art. The device 20 is then pointed towards a specific point, such as the moon 26.

The device 20 according to the invention includes conventional functionality of a mobile device, that is, a data communication means, display, speaker and alike. The mobile device is typically capable of executing a computer program. In addition to conventional functionality, the mobile device includes positioning system 22, such as a GPS-receiver, or other positioning means and orientation detection means 23, such as sensors for detecting the direction to which the mobile device is pointed to. The location and orientation information is then transmitted to the server 24 by using the network connection 25.

The server computes the location of the specific point. For example, if the specific point is a building, the location can be retrieved from a database. If the specific point is a celestial body, the location must be computed. In there are many points in the line of pointing, several different messages can be retrieved or the device can be configured to retrieve only a portion of them. For example, if there is a building in front of the moon the information assigned to the moon can be retrieved. However, if the user has configured the device to retrieve only from visible objects, the server does not return the message from the moon. However, this information is not known at the device 20 and must be computed in the server. Lastly, the retrieved messages are displayed on a display 21 or played by a speaker or delivered by other suitable means.

It is obvious to a person skilled in the art that with the advancement of technology, the basic idea of the invention may be implemented in various ways. The invention and its embodiments are thus not limited to the examples described above; instead they may vary within the scope of the claims.

1. A method, the method comprising:
pointing a mobile device towards a specific point;
determining a location of the mobile device;
determining an orientation of the mobile device;
computing a viewing direction from the mobile device to the specific point; and
retrieving a message from a server based on the viewing direction computed.

2. A method according to claim 1, wherein the message retrieved is a viewable object.

3. A method according to claim 1, wherein the message retrieved is a sound message.

4. A method according to claim 1, the method further comprising:
pointing the device towards a second specific point for determining a sector, wherein the sector comprises at least one specific point for retrieving at least one message.

5. A method according to claim 1, wherein the specific point is a celestial body.

6. A method for providing messages, wherein a message source is determined in a device by pointing the device towards a specific point, the method comprising:
receiving a first location and an orientation of the device requesting a message;
computing a second location of the specific point based on the first location and the orientation of the device requesting a message; and
transmitting messages assigned to the specific point.

7. A method according to claim 6, wherein the specific point is a celestial body and the method further comprises computing the second location of the specific point based on the first location and the orientation of the device and a known orbit of the celestial body.

8. A method according to claim 6, the method further comprising:
receiving a second specific point for determining a sector and transmitting messages assigned to said sector.

9. A mobile device for retrieving a message from a communication network by pointing the mobile device towards a specific point, the mobile device comprising:
a positioning module for determining a location of the mobile device;
at least one orientation sensor for determining an orientation of the mobile device;
a processor for computing a viewing direction of the mobile device to the specific point; and
a data communication connection for retrieving the message from a server of the communication network.

10. A mobile device for retrieving a message from a communication network by pointing the mobile device towards a specific point, the mobile device comprising:
positioning means for determining a location of the mobile device;
orientation means for determining an orientation of the mobile device;
computing means for computing a viewing direction of the mobile device to the specific point; and
data communication means for retrieving the message from a server of the communication network.

11. A system for retrieving a message from a communication network, the system comprising:
a device;
a server; and
a data communication connection between the device and the server,
wherein the device comprises
positioning means for determining a location of the mobile device,
at least one orientation sensor determining an orientation of the mobile device,
a processor for computing a viewing direction of the mobile device to a specific point, and
data communication means for retrieving the message from a server, and
wherein the server comprises
a database for storing messages and locations of specific points, and
a processor for computing locations of other specific points.

12. A server for providing a message to a device based on at least one specific point toward which the device has been pointed, the server comprising:
a network connection;
a database for storing messages and locations for specific points; and
a processor for computing actual locations for other specific points.

13. A computer program embodied on a computer readable medium, for providing location and orientation-based messages, wherein the computer program is configured to perform:
receiving a first location and an orientation of a device requesting a message;
computing a second location of a specific point based on the first location and the orientation of the device requesting the message; and
transmitting messages assigned to the specific point.

14. A computer program according to claim 13, wherein the specific point is a celestial body and the computer program is configured to compute the second location of the specific point based on the first location and the orientation of the device and a known orbit of the celestial body.

15. A computer program according to claim 13, wherein the computer program is further configured to receive a second specific point for determining a sector and to transmit messages assigned to said sector.

16. A computer program embodied on a computer-readable medium, for retrieving location and orientation-based messages, wherein the computer program is configured to perform:
determining a location of a mobile device;
determining an orientation of the mobile device;
computing a viewing direction from the mobile device to a specific point; and
retrieving a message from a server based on the viewing direction computed.

17. A computer program according to claim 16, wherein the message retrieved is a viewable object.

18. A computer program according to claim 16, wherein the message retrieved is a sound message.

19. A computer program according to claim 16, wherein the computer program is further configured to point toward a second specific point for determining a sector, wherein the sector comprises at least one specific point for retrieving at least one message.

20. A computer program according to claim 16, wherein the specific point is a celestial body.
